(19) United States
(12) Patent Application Publication
(10) Pub. No.: US 2023/0149947 A1
(43) Pub. Date: May 18, 2023

(54) VEHICLE DUST REMOVING APPARATUS

(71) Applicant: TOYOTA JIDOSHA KABUSHIKI KAISHA, Toyota-shi Aichi-ken (JP)

(72) Inventor: Kazuki KOMORIYA, Toyota-shi Aichi-ken (JP)

(73) Assignee: TOYOTA JIDOSHA KABUSHIKI KAISHA, Toyota-shi Aichi-ken (JP)

(21) Appl. No.: 17/965,943

(22) Filed: Oct. 14, 2022

(30) Foreign Application Priority Data
Nov. 17, 2021 (JP) 2021-187364

(51) Int. Cl. B03C 3/38; B08B 5/02; B03C 3/36; B03C 3/47

(52) U.S. Cl. CPC B03C 3/38; B08B 5/02; B03C 3/361; B03C 3/47; B03C 2201/30

(57) ABSTRACT

A vehicle dust removing apparatus includes an acquisition unit configured to acquire a temperature of an object to be processed of a vehicle that runs in a low-temperature environment, a temperature of the object to be processed being configured to be able to be increased, a dust removing unit configured to be able to reduce a temperature of gas to be sprayed to the object to be processed and remove dust by spraying gas to the object to be processed, and a control unit configured to control spraying of the gas by the dust removing unit by at least one of increasing the temperature of the object to be processed and reducing the temperature of the gas based on the temperature of the object to be processed, acquired by the acquisition unit.

### CROSS-REFERENCE TO RELATED APPLICATION

This application claims priority to Japanese Patent Application No. 2021-187364 filed on Nov. 17, 2021, incorporated herein by reference in its entirety.

### BACKGROUND

### 1. Technical Field

The disclosure relates to a vehicle dust removing apparatus.

### 2. Description of Related Art

There is known an antistatic dust removing apparatus that eliminates static electricity and removes dust from an object to be processed by spraying compressed air in an air gun to the object to be processed together with ions produced from an ionizer (see, for example, Japanese Unexamined Patent Application Publication No. 2009-106843 (JP 2009-106843 A)).

### SUMMARY

However, in the case where the object to be processed is a window glass of a vehicle that runs in a low-temperature environment, if gas is sprayed to the surface of the window glass, the window glass can break when there is a large difference between the temperature of the sprayed gas and the temperature of the surface of the window glass. In other words, an object to be processed, from which dust is to be removed, can be damaged by the sprayed gas.

The disclosure provides a vehicle dust removing apparatus capable of reducing damage to an object to be processed, due to a temperature difference from gas at the time when the gas is sprayed to the object to be processed of the vehicle that runs in a low-temperature environment.

A first aspect of the disclosure relates to a vehicle dust removing apparatus. The vehicle dust removing apparatus includes an acquisition unit configured to acquire a temperature of an object to be processed of a vehicle that runs in a low-temperature environment, a temperature of the object to be processed being configured to be able to be increased, a dust removing unit configured to be able to reduce a temperature of gas to be sprayed to the object to be processed and remove dust by spraying gas to the object to be processed, and a control unit configured to control spraying of the gas by the dust removing unit by at least one of increasing the temperature of the object to be processed and reducing the temperature of the gas based on the temperature of the object to be processed, acquired by the acquisition unit.

With the above aspect, the control unit that controls spraying of gas by the dust removing unit performs at least one of increasing the temperature of the object to be processed and reducing the temperature of the gas based on the temperature of the object to be processed, acquired by the acquisition unit. Therefore, a temperature difference between the object to be processed and the gas is reduced. Hence, at the time of removing dust by spraying gas to the object to be processed of the vehicle that runs in a low-temperature environment, damage to the object to be processed due to a temperature difference from the gas is reduced.

The vehicle dust removing apparatus of a second aspect is the vehicle dust removing apparatus of the first aspect, and the control unit may be configured to disable spraying of the gas by the dust removing unit based on the temperature of the object to be processed, acquired by the acquisition unit.

According to the disclosure of the second aspect, the control unit disables spraying of the gas by the dust removing unit based on the temperature of the object to be processed, acquired by the acquisition unit. Therefore, the gas is not sprayed to the object to be processed in a state where there is a large temperature difference between the object to be processed and the gas. Hence, damage to the object to be processed of the vehicle that runs in a low-temperature environment is prevented.

The vehicle dust removing apparatus of a third aspect is the vehicle dust removing apparatus of the first aspect, and the dust removing unit may be configured to be able to select and spray any one of carbon dioxide, nitrogen, and hydrogen, and the control unit may be configured to, when the temperature of the object to be processed, acquired by the acquisition unit, is lower than or equal to a solidification point of carbon dioxide, increase the temperature of the object to be processed to a temperature higher than the solidification point of carbon dioxide or cause the dust removing unit to select nitrogen or hydrogen.

According to the disclosure of the third aspect, the control unit increases the temperature of the object to be processed to a temperature higher than the solidification point of carbon dioxide in a state where the temperature of the object to be processed, acquired by the acquisition unit, is lower than or equal to the solidification point of carbon dioxide. Therefore, unnecessary carbon dioxide is effectively used. The control unit causes the dust removing unit to select nitrogen or hydrogen when the temperature of the object to be processed, acquired by the acquisition unit, is lower than or equal to the solidification point of carbon dioxide. Hence, even with the vehicle that runs in a low-temperature environment in which the temperature of the object to be processed is lower than or equal to the solidification point of carbon dioxide, it is possible to remove dust by spraying gas to the object to be processed.

The vehicle dust removing apparatus of a fourth aspect is the vehicle dust removing apparatus of any one of the first aspect to the third aspect, and the vehicle may be a vehicle used on a surface other than a surface of the Earth.

According to the disclosure of the fourth aspect, it is possible to remove dust by spraying gas to the object to be processed of the vehicle that is used on a surface other than the surface of the Earth.

As described above, according to the aspect of the disclosure, it is possible to reduce damage to the object to be processed, due to a temperature difference from gas at the time when the gas is sprayed to the object to be processed of the vehicle that runs in a low-temperature environment.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the configuration of a vehicle dust removing apparatus according to embodiments;

FIG. 2 is a flowchart showing the operation of the vehicle dust removing apparatus according to a first embodiment;

FIG. 3 is a flowchart showing the operation of the vehicle dust removing apparatus according to a second embodiment; and

FIG. 4 is a flowchart showing the operation of the vehicle dust removing apparatus according to a third embodiment.

### DETAILED DESCRIPTION OF EMBODIMENTS

Hereinafter, embodiments of the disclosure will be described in detail with reference to the accompanying drawings. A vehicle 10 that includes a vehicle dust removing apparatus 20 according to the present embodiments is used in a low-temperature environment. Examples of the low-temperature environment according to the present embodiments include surfaces other than the surface of the Earth, such as the surface of the moon and the surface of Mars. Therefore, a rover 12 that includes a manned pressurized cabin and searches while running on the lunar surface or the like is adopted as an example of the vehicle 10 according to the present embodiments.

A window glass 14 for viewing outside, provided for the rover 12, is adopted as an example of an object to be processed according to the present embodiments. Regolith or the like easily adheres to the outermost surface of the window glass 14 of the rover 12 that searches while running on the lunar surface or the like. The regolith or the like can interfere with visibility at the time when an occupant views outside the vehicle through the window glass 14.

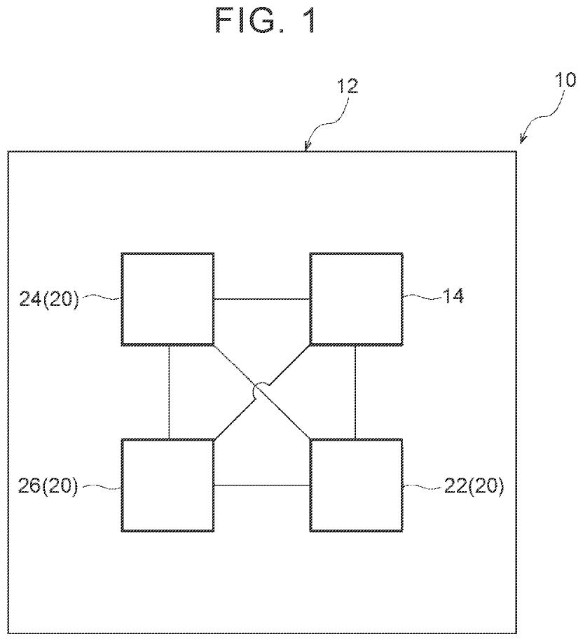

As shown in FIG. 1, the vehicle dust removing apparatus 20 includes an acquisition unit 22 that acquires the temperature of the window glass 14 of the rover 12, a dust removing unit 24 that removes regolith or the like by spraying gas to the outermost surface of the window glass 14, and a control unit 26 that controls spraying of gas by the dust removing unit 24 by at least one of increasing the temperature of the window glass 14 and reducing the temperature of the gas based on the temperature of the window glass 14, acquired by the acquisition unit 22.

Examples of the gas include carbon dioxide, nitrogen, and hydrogen. At least carbon dioxide, nitrogen, and hydrogen are stored in the dust removing unit 24. In other words, the dust removing unit 24 is configured to be able to select at least any one of carbon dioxide, nitrogen, and hydrogen and spray the at least any one of carbon dioxide, nitrogen, and hydrogen to the outermost surface of the window glass 14. Carbon dioxide is unnecessary gas that needs to be emitted from the inside of the vehicle and can be easily supplied by the breath of an occupant, so carbon dioxide is suitable as gas to be sprayed. The temperatures of the gases are also configured to be acquired by the acquisition unit 22.

The dust removing unit 24 includes a cooling device (not shown) capable of cooling gases. The dust removing unit 24 is configured to be able to reduce the temperature of gas by control of the control unit 26. The dust removing unit 24 mainly selects and uses carbon dioxide as gas, so, even when the temperature of the gas is reduced, carbon dioxide is not reduced in temperature into dry ice. In other words, the dust removing unit 24 is not configured to reduce the temperature of carbon dioxide to the solidification point of carbon dioxide.

The window glass 14 includes a heating device (not shown) capable of heating the surface of the window glass 14. The window glass 14 is configured to be able to increase the temperature of the surface of the window glass 14 by control of the control unit 26. A selected configuration may be adopted as the heating device. For example, a heating wire may be disposed inside the surface of the window glass 14 to warm up. Alternatively, a heater may be disposed near the surface of the window glass 14, and the surface of the window glass 14 may be warmed up by the heater.

Next, the operation of the vehicle dust removing apparatus 20 according to the present embodiment, configured as described above, will be described.

Initially, a first embodiment will be described. In this first embodiment, carbon dioxide is used as gas.

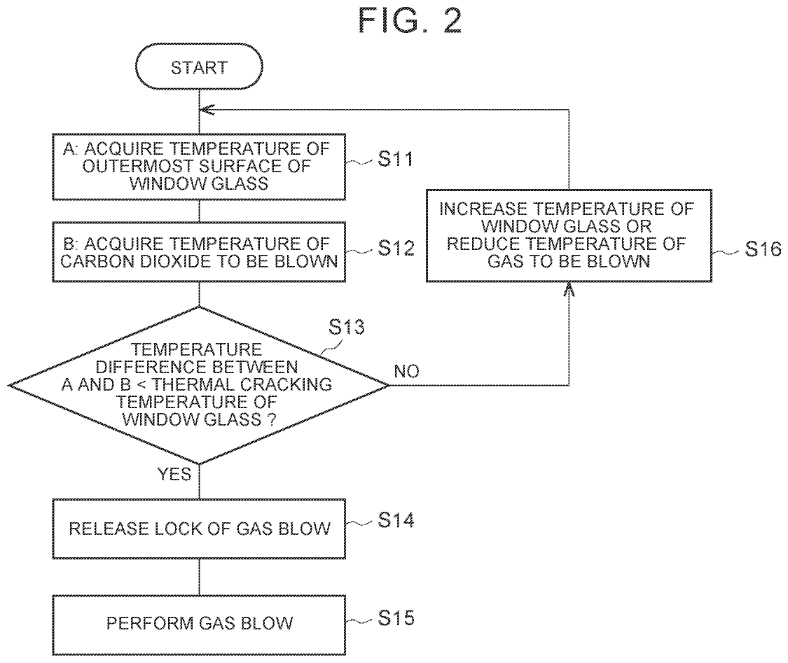

As shown in FIG. 2, the acquisition unit 22 acquires the temperature A of the outermost surface of the window glass 14 (step S11). The acquisition unit 22 acquires the temperature B of carbon dioxide to be sprayed (blown) (step S12). The control unit 26 determines whether the temperature difference between the temperature A of the outermost surface of the window glass 14 and the temperature B of carbon dioxide to be blown is less than a thermal cracking temperature of the window glass 14 (step S13).

When the temperature difference between the temperature A of the outermost surface of the window glass 14 and the temperature B of carbon dioxide to be blown is less than the thermal cracking temperature of the window glass 14, the control unit 26 sends a signal for releasing the lock of gas blow to the dust removing unit 24 (step S14). Then, the dust removing unit 24 is controlled by the control unit 26 to perform gas blow (step S15). In other words, the dust removing unit 24 sprays carbon dioxide to the outermost surface of the window glass 14 to remove dust on the outermost surface of the window glass 14.

On the other hand, when the temperature difference between the temperature A of the outermost surface of the window glass 14 and the temperature B of carbon dioxide to be blown is not less than the thermal cracking temperature of the window glass 14, in other words, when the temperature difference between the temperature A of the outermost surface of the window glass 14 and the temperature B of carbon dioxide to be blown is greater than or equal to the thermal cracking temperature of the window glass 14, the control unit 26 increases the temperature of the window glass 14 by activating the heating device or reduces the temperature of carbon dioxide by activating the cooling device of the dust removing unit 24 (step S16).

In other words, the temperature difference between the temperature A of the outermost surface of the window glass 14 and the temperature B of carbon dioxide to be blown is reduced. Thus, at the time of removing dust by spraying carbon dioxide to the outermost surface of the window glass 14, it is possible to reduce or prevent damage (thermal cracking) of the window glass 14 due to a temperature difference from carbon dioxide.

In step S16, when the temperature difference between the temperature A of the outermost surface of the window glass 14 and the temperature B of carbon dioxide to be blown is reduced, the process returns to step S11, the acquisition unit 22 acquires the temperature A of the outermost surface of the window glass 14, and, in step S12, acquires the temperature B of carbon dioxide to be blown. Then, in step S13, the control unit 26 determines again whether the temperature difference between the temperature A of the outermost surface of the window glass 14 and the temperature B of carbon dioxide to be blown is less than the thermal cracking temperature of the window glass 14.

Alternatively, in step S16, the control unit 26 may increase the temperature of the window glass 14 by activating the heating device and decrease the temperature of carbon dioxide by activating the cooling device of the dust removing unit 24. In other words, it is applicable as long as, in step S16, at least one of increasing the temperature of the window glass 14 and reducing the temperature of carbon dioxide is performed. When both the heating device and the cooling device are activated, it is possible to further quickly reduce the temperature difference between the temperature A of the outermost surface of the window glass 14 and the temperature B of carbon dioxide to be blown.

Although not shown in the drawing, in step S13, when the control unit 26 determines that the temperature difference between the temperature A of the outermost surface of the window glass 14 and the temperature B of carbon dioxide to be blown is not less than the thermal cracking temperature of the window glass 14, the control unit 26 may be configured to simply disable spraying of carbon dioxide by the dust removing unit 24 (not send a signal for releasing the lock of gas blow). In this case, since, in a state where there is a large temperature difference between the temperature A of the outermost surface of the window glass 14 and the temperature B of carbon dioxide, the carbon dioxide is not sprayed to the outermost surface of the window glass 14, it is possible to prevent damage to the window glass 14.

Next, a second embodiment will be described. In this second embodiment as well, carbon dioxide is used as gas.

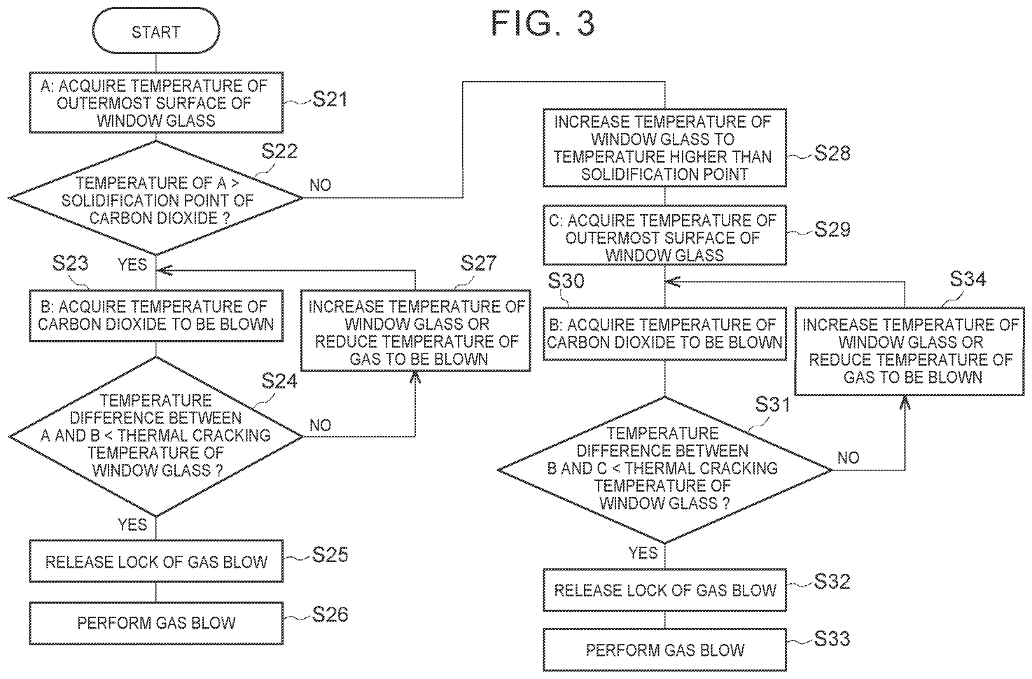

As shown in FIG. 3, the acquisition unit 22 acquires the temperature A of the outermost surface of the window glass 14 (step S21). Then, the control unit 26 determines whether the temperature A of the outermost surface of the window glass 14 is higher than the solidification point of carbon dioxide (step S22). When the temperature A of the outermost surface of the window glass 14 is higher than the solidification point of carbon dioxide, the acquisition unit 22 acquires the temperature B of carbon dioxide to be sprayed (to be blown) (step S23).

The control unit 26 determines whether the temperature difference between the temperature A of the outermost surface of the window glass 14 and the temperature B of carbon dioxide to be blown is less than the thermal cracking temperature of the window glass 14 (step S24). When the temperature difference between the temperature A of the outermost surface of the window glass 14 and the temperature B of carbon dioxide to be blown is less than the thermal cracking temperature of the window glass 14, the control unit 26 sends a signal for releasing the lock of gas blow to the dust removing unit 24 (step S25).

Then, the dust removing unit 24 is controlled by the control unit 26 to perform gas blow (step S26). In other words, the dust removing unit 24 sprays carbon dioxide to the outermost surface of the window glass 14 to remove dust on the outermost surface of the window glass 14.

On the other hand, when the temperature difference between the temperature A of the outermost surface of the window glass 14 and the temperature B of carbon dioxide to be blown is not less than the thermal cracking temperature of the window glass 14, in other words, when the temperature difference between the temperature A of the outermost surface of the window glass 14 and the temperature B of carbon dioxide to be blown is greater than or equal to the thermal cracking temperature of the window glass 14, the control unit 26 increases the temperature of the window glass 14 by activating the heating device or reduces the temperature of carbon dioxide by activating the cooling device of the dust removing unit 24 (step S27).

In other words, the temperature difference between the temperature A of the outermost surface of the window glass 14 and the temperature B of carbon dioxide to be blown is reduced. Thus, as in the case of the first embodiment, at the time of removing dust by spraying carbon dioxide to the outermost surface of the window glass 14, it is possible to reduce or prevent damage (thermal cracking) of the window glass 14 due to a temperature difference from carbon dioxide.

In step S27, when the temperature difference between the temperature A of the outermost surface of the window glass 14 and the temperature B of carbon dioxide to be blown is reduced, the process returns to step S23, and the acquisition unit 22 acquires the temperature B of carbon dioxide to be blown. Then, in step S24, the control unit 26 determines again whether the temperature difference between the temperature A of the outermost surface of the window glass 14 and the temperature B of carbon dioxide to be blown is less than the thermal cracking temperature of the window glass 14.

Alternatively, in step S27, the control unit 26 may increase the temperature of the window glass 14 by activating the heating device and reduce the temperature of carbon dioxide by activating the cooling device of the dust removing unit 24. In other words, it is applicable as long as, in step S27, at least one of increasing the temperature of the window glass 14 and reducing the temperature of carbon dioxide is performed. When both the heating device and the cooling device are activated, it is possible to further quickly reduce the temperature difference between the temperature A of the outermost surface of the window glass 14 and the temperature B of carbon dioxide to be blown, as in the case of the first embodiment.

When the temperature A of the outermost surface of the window glass 14 is not higher than the solidification point of carbon dioxide, in other words, when the temperature A of the outermost surface of the window glass 14 is lower than or equal to the solidification point of carbon dioxide, the control unit 26 increases the temperature of the outermost surface of the window glass 14 to a temperature higher than the solidification point of carbon dioxide by activating the heating device (step S28).

The acquisition unit 22 acquires the temperature C of the outermost surface of the window glass 14 (step S29). The acquisition unit 22 acquires the temperature B of carbon dioxide to be blown (step S30). Then, the control unit 26 determines whether the temperature difference between the temperature C of the outermost surface of the window glass 14 and the temperature B of carbon dioxide to be blown is less than the thermal cracking temperature of the window glass 14 (step S31).

When the temperature difference between the temperature C of the outermost surface of the window glass 14 and the temperature B of carbon dioxide to be blown is less than the thermal cracking temperature of the window glass 14, the control unit 26 sends a signal for releasing the lock of gas blow to the dust removing unit 24 (step S32). Then, the dust removing unit 24 is controlled by the control unit 26 to perform gas blow (step S33). In other words, the dust removing unit 24 sprays carbon dioxide to the outermost surface of the window glass 14 to remove dust on the outermost surface of the window glass 14.

On the other hand, when the temperature difference between the temperature C of the outermost surface of the window glass 14 and the temperature B of carbon dioxide to be blown is not less than the thermal cracking temperature of the window glass 14, in other words, when the temperature difference between the temperature C of the outermost surface of the window glass 14 and the temperature B of carbon dioxide to be blown is greater than or equal to the thermal cracking temperature of the window glass 14, the control unit 26 increases the temperature of the window glass 14 by activating the heating device or reduces the temperature of carbon dioxide by activating the cooling device of the dust removing unit 24 (step S34).

In other words, the temperature difference between the temperature C of the outermost surface of the window glass 14 and the temperature B of carbon dioxide to be blown is reduced. Thus, at the time of removing dust by spraying carbon dioxide to the outermost surface of the window glass 14, it is possible to reduce or prevent damage (thermal cracking) of the window glass 14 due to a temperature difference from carbon dioxide.

In step S34, when the temperature difference between the temperature C of the outermost surface of the window glass 14 and the temperature B of carbon dioxide to be blown is reduced, the process returns to step S30, and the acquisition unit 22 acquires the temperature B of carbon dioxide to be blown. Then, in step S31, the control unit 26 determines again whether the temperature difference between the temperature C of the outermost surface of the window glass 14 and the temperature B of carbon dioxide to be blown is lower than the thermal cracking temperature of the window glass 14.

In this way, according to the second embodiment, even when the temperature of the outermost surface of, for example, the window glass 14 provided for the rover 12 to be used in a low-temperature environment, such as on the lunar surface, is lower than or equal to the solidification point of carbon dioxide, it is possible to remove dust by spraying carbon dioxide to the outermost surface of the window glass 14. In addition, unnecessary carbon dioxide is effectively used.

Lastly, a third embodiment will be described. In this third embodiment, carbon dioxide is used as initial gas.

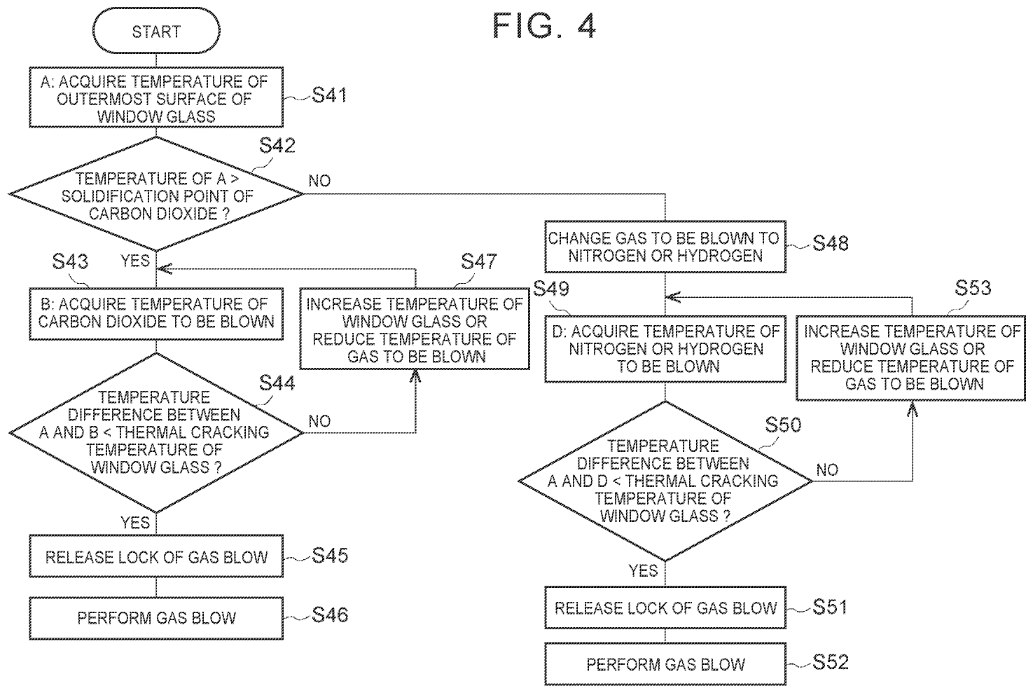

As shown in FIG. 4, the acquisition unit 22 acquires the temperature A of the outermost surface of the window glass 14 (step S41). Then, the control unit 26 determines whether the temperature A of the outermost surface of the window glass 14 is higher than the solidification point of carbon dioxide (step S42). When the temperature A of the outermost surface of the window glass 14 is higher than the solidification point of carbon dioxide, the acquisition unit 22 acquires the temperature B of carbon dioxide to be sprayed (to be blown) (step S43).

The control unit 26 determines whether the temperature difference between the temperature A of the outermost surface of the window glass 14 and the temperature B of carbon dioxide to be blown is less than the thermal cracking temperature of the window glass 14 (step S44). When the temperature difference between the temperature A of the outermost surface of the window glass 14 and the temperature B of carbon dioxide to be blown is less than the thermal cracking temperature of the window glass 14, the control unit 26 sends a signal for releasing the lock of gas blow to the dust removing unit 24 (step S45). Then, the dust removing unit 24 is controlled by the control unit 26 to perform gas blow (step S46). In other words, the dust removing unit 24 sprays carbon dioxide to the outermost surface of the window glass 14 to remove dust on the outermost surface of the window glass 14.

On the other hand, when the temperature difference between the temperature A of the outermost surface of the window glass 14 and the temperature B of carbon dioxide to be blown is not less than the thermal cracking temperature of the window glass 14, in other words, when the temperature difference between the temperature A of the outermost surface of the window glass 14 and the temperature B of carbon dioxide to be blown is greater than or equal to the thermal cracking temperature of the window glass 14, the control unit 26 increases the temperature of the window glass 14 by activating the heating device or reduces the temperature of carbon dioxide by activating the cooling device of the dust removing unit 24 (step S47).

In other words, the temperature difference between the temperature A of the outermost surface of the window glass 14 and the temperature B of carbon dioxide to be blown is reduced. Thus, as in the case of the first embodiment and the second embodiment, at the time of removing dust by spraying carbon dioxide to the outermost surface of the window glass 14, it is possible to reduce or prevent damage (thermal cracking) of the window glass 14 due to a temperature difference from carbon dioxide.

In step S47, when the temperature difference between the temperature A of the outermost surface of the window glass 14 and the temperature B of carbon dioxide to be blown is reduced, the process returns to step S43, and the acquisition unit 22 acquires the temperature B of carbon dioxide to be blown. Then, in step S44, the control unit 26 determines again whether the temperature difference between the temperature A of the outermost surface of the window glass 14 and the temperature B of carbon dioxide to be blown is less than the thermal cracking temperature of the window glass 14.

Alternatively, in step S47, the control unit 26 may increase the temperature of the window glass 14 by activating the heating device and reduce the temperature of carbon dioxide by activating the cooling device of the dust removing unit 24. In other words, it is applicable as long as, in step S47, at least one of increasing the temperature of the window glass 14 and reducing the temperature of carbon dioxide is performed. When both the heating device and the cooling device are activated, it is possible to further quickly reduce the temperature difference between the temperature A of the outermost surface of the window glass 14 and the temperature B of carbon dioxide to be blown, as in the case of the first embodiment and the second embodiment.

When the temperature A of the outermost surface of the window glass 14 is not higher than the solidification point of carbon dioxide, in other words, when the temperature A of the outermost surface of the window glass 14 is lower than or equal to the solidification point of carbon dioxide, the control unit 26 causes the dust removing unit 24 not to select carbon dioxide and to select nitrogen or hydrogen lower in the solidification point than carbon dioxide as gas to be blown (step S48).

The acquisition unit 22 acquires the temperature D of nitrogen or hydrogen to be blown (step S49). In addition, the control unit 26 determines whether the temperature difference between the temperature A of the outermost surface of the window glass 14 and the temperature D of nitrogen or hydrogen to be blown is less than the thermal cracking temperature of the window glass 14 (step S50).

When the temperature difference between the temperature A of the outermost surface of the window glass 14 and the temperature D of nitrogen or hydrogen to be blown is less than the thermal cracking temperature of the window glass 14, the control unit 26 sends a signal for releasing the lock of gas blow to the dust removing unit 24 (step S51). Then, the dust removing unit 24 is controlled by the control unit 26 to perform gas blow (step S52). In other words, the dust removing unit 24 sprays nitrogen or hydrogen to the outermost surface of the window glass 14 to remove dust on the outermost surface of the window glass 14.

On the other hand, when the temperature difference between the temperature A of the outermost surface of the window glass 14 and the temperature D of nitrogen or hydrogen to be blown is not less than the thermal cracking temperature of the window glass 14, in other words, when the temperature difference between the temperature A of the outermost surface of the window glass 14 and the temperature D of nitrogen or hydrogen to be blown is greater than or equal to the thermal cracking temperature of the window glass 14, the control unit 26 increases the temperature of the window glass 14 by activating the heating device or reduces the temperature of nitrogen or hydrogen by activating the cooling device of the dust removing unit 24 (step S53).

In other words, the temperature difference between the temperature A of the outermost surface of the window glass 14 and the temperature D of nitrogen or hydrogen to be blown is reduced. Thus, at the time of removing dust by spraying nitrogen or hydrogen to the outermost surface of the window glass 14, it is possible to reduce or prevent damage (thermal cracking) of the window glass 14 due to a temperature difference from nitrogen or hydrogen.

In step S53, when the temperature difference between the temperature A of the outermost surface of the window glass 14 and the temperature D of nitrogen or hydrogen to be blown is reduced, the process returns to step S49, and the acquisition unit 22 acquires the temperature D of nitrogen or hydrogen to be blown. In addition, in step S50, the control unit 26 determines again whether the temperature difference between the temperature A of the outermost surface of the window glass 14 and the temperature D of nitrogen or hydrogen to be blown is less than the thermal cracking temperature of the window glass 14.

In this way, according to the third embodiment, even when the temperature of the outermost surface of, for example, the window glass 14 provided for the rover 12 to be used in a low-temperature environment, such as on the lunar surface, is lower than or equal to the solidification point of carbon dioxide, it is possible to remove dust by spraying carbon dioxide or nitrogen or hydrogen to the outermost surface of the window glass 14.

The vehicle dust removing apparatus 20 according to the present embodiments has been described based on the drawings; however, the vehicle dust removing apparatus 20 according to the present embodiments is not limited to the illustrated ones and may be modified by design as needed without departing from the scope of the disclosure. For example, in the first embodiment, air in the rover 12 may be used as gas to be blown.

The object to be processed is not limited to the window glass 14 provided for the rover 12 to be used on the lunar surface or the like. The vehicle dust removing apparatus 20 according to the first embodiment is also applicable to a window glass (not shown) or the like of a vehicle 10 (a general vehicle not the rover 12) that runs in a region in which the outside air temperature is lower than −60° C., such as an arctic region on the earth.

What is claimed is:

1. A vehicle dust removing apparatus, the vehicle dust removing apparatus comprising:
an acquisition unit configured to acquire a temperature of an object to be processed of a vehicle that runs in a low-temperature environment, a temperature of the object to be processed being configured to be able to be increased;
a dust removing unit configured to be able to reduce a temperature of gas to be sprayed to the object to be processed and remove dust by spraying the gas to the object to be processed; and
a control unit configured to control spraying of the gas by the dust removing unit by at least one of increasing the temperature of the object to be processed and reducing the temperature of the gas based on the temperature of the object to be processed, acquired by the acquisition unit.

2. The vehicle dust removing apparatus according to claim 1, wherein the control unit is configured to disable spraying of the gas by the dust removing unit based on the temperature of the object to be processed, acquired by the acquisition unit.

3. The vehicle dust removing apparatus according to claim 1, wherein:
the dust removing unit is configured to be able to select and spray any one of carbon dioxide, nitrogen, and hydrogen; and
the control unit is configured to, when the temperature of the object to be processed, acquired by the acquisition unit, is lower than or equal to a solidification point of carbon dioxide, increase the temperature of the object to be processed to a temperature higher than the solidification point of carbon dioxide or cause the dust removing unit to select nitrogen or hydrogen.

4. The vehicle dust removing apparatus according to claim 1, wherein the vehicle is a vehicle used on a surface other than a surface of the Earth.
